(19) United States
(12) Patent Application Publication
(10) Pub. No.: US 2010/0329355 A1
(43) Pub. Date: Dec. 30, 2010

(54) SYSTEM AND METHOD FOR CONFIGURABLE PACKET STREAMING

(75) Inventors: Gyan Prakash Pandey, Bangalore (IN); Gyana Ranjan Senapati, Bangalore (IN); Krathi Lakshmi, Bangalore (IN)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V, Eindhoven (NL)

(21) Appl. No.: 12/495,414

(22) Filed: Jun. 30, 2009

(51) Int. Cl. H04N 7/12; H04N 5/44

(52) U.S. Cl. 375/240.25; 348/725; 348/E05.096; 375/E07.027

(57) ABSTRACT

In a channel zapping though multiple channels, each channel select identifies a new packet stream channel and the video coding standard of the channel is identified. Based on the video coding standard an optimal input buffer delay is identified, a packet stream for the new channel delayed by the optimal input buffer delay, and decoded by a decoding process according to video coding standard. Optionally, based on the video coding standard an optimal an optimal decoding processing delay is identified and the decoding applies an associated processing delay.

### TECHNICAL FIELD

Embodiments relate generally to reception and decoding of streaming multimedia broadcast.

### BACKGROUND

There are various methods, system architectures and coding standards known for distributing digitized multimedia content from a source to a user, or a plurality of users, and these may be collectively referenced as Digital Television (DTV).

One example of DTV is Internet Protocol Television (IPTV), in which a source distributes multimedia programs such as, for example, movies through the Internet to end users as digital packet streams. In IPTV, a given packet stream typically carries information for one multimedia program and, therefore, is typically referred to as a “channel.” Each user, typically by joining multicasting “groups,” receives only the particular channel(s) the user has selected for viewing, typically from a large number of available channels.

Another example of DTV is over-the-air broadcast digital television such as, for example, Digital Terrestrial Television (DTT). In broadcast DTV, the channels are typically, but not necessarily, multiplexed using frequency division multiplexing of sub-bands within a large, aggregate band. The user typically has an antenna, which receives the aggregate band and applies a local channel selector and demodulator to recover selected channel of DTV data. The particulars of the various signal modulation schemes and data protocols known for broadcast DTV are not pertinent to this disclosure, but one example is the ATSC (Advanced Television Systems Committee) modulation/protocol used for DTT in the United States.

Another example known DTV is satellite DTV, generally comparable to broadcast DTV but typically having a larger aggregate band and, hence, more channels, and typically centered at a significantly higher carrier frequency than DTT type broadcast DTV.

Still another example known DTV is cable DTV such as, for example the services provides by Comcast and various similar entities. Details of cable DTV architectures, technologies and protocols are beyond the scope of information needed to practice the embodiments described herein and, therefore, are omitted.

Turning to the IPTV type of DTV, in a typical example IPTV system each of one or more users a reception and playback equipment such as, for example, a home entertainment center having a video display screen and an audio speaker subsystem, connected to the Internet via, for example, a set-top box (STB) or equivalent.

The meaning of the term “set-top box” or “STB,” as used in this description, is as follows: except where otherwise stated or otherwise made clear from a particular context, the term “STB” encompasses the functions of any or all of a user interface to an IPTV service provider's Internet access link, a user interface to a cable DTV service, and a user interface to a satellite DTV service. In certain instances, for purposes of better clarity, in particular descriptions of example STB operations relating to IPTV, the STB may be, but is not necessarily, referenced as an “IPTV STB.”

Continuing with overview description of a typical IPTV system, in such a system each user's viewing station has an STB typically having an Internet interface processor, which handles protocol interfacing and communications between the user and the IPTV service provider. Examples of such STB to IPTV service provider communication include, for example, the user receiving program guides from one the IPTV service provider, the user sending channel selection commands to the IPTV service provider, and other exchanging of various data between the STB and the IPTV service provider such as, for example, billing information and various authorization codes.

An IPTV service provider typically offers a plurality of channels, by having various server resources of the IPTV service host a corresponding plurality of “multicast groups.” Relevant theory and operation of IPTV multicasting and “multicast groups” are known to persons of ordinary skill in the art, to an extent sufficient to practice according to the described embodiments and, therefore, further detailed description is omitted.

In a typical IPTV system operation, a program guide or equivalent may be selectively displayed on or more video screens within view of the user. The program guide may display, in various formats, all or part of the universe of IPTV channels available through the IPTV service provider.

An IPTV user may chooses from such a program guide based on, for example, movie title, names of actors or sports teams, and enter a command into the STB via any of the various interface devices as known in the IPTV arts. Alternatively, the user may enter a “next” or equivalent command by which the user effectively selects another channel, according to some channel ordering scheme. The STB, in response to the user's channel select or “next” command, typically identifies the channel and sends a “join” message to a node of the network, which may a node nearest the user. Such a “nearest node” may, for example, be a router within the Internet, or may be an edge router within a communication link between the STB, or a plurality of STBs, and the Internet. The “join” message may be in accordance with the Internet Group Management Protocol (IGMP).

In response to the received join message the nearest node determines whether or it is already receiving the channel identified by the join message such as, for example, from a node upstream in the direction back toward the head end of the IPTV service provider. If the nearest node determines it is not already receiving the selected channel, it may send a message upstream to another node which, in turn, determines whether or not it is already receiving the selected channel. Such messaging may, for example, use the known Protocol Independent Messaging (PIM). This process continues, typically in an upstream direction from node to node, until a node determines it is already receiving the selected channel. That node then multicasts the selected channel, and the downstream nodes then repeat and re-broadcast the channel downstream, typically according to a multicast tree created by the nodes during the IGMP-PIM process, for reception as a packet stream at the STB.

The user's STB, however, does not immediately output valid video data to the user's video screen. Instead, valid video output from the STB, and the resulting display of a good picture, can only occur after the elapse of a “zapping time.” Zapping time is due to multiple factors, and a most significant of these is that due to the compression code applied to the channel data by the IPTV service provider prior to broadcasting the channel to the users, a certain number of video frames must be collected at the receiving end before starting the decoding, i.e., the decompression, operation. More specifically, as known on the DTV arts, most currently used compression code standards, such as, for example, MPEG2, H.264 (also known as “MPEG4-AVC”) and Audio Video Standard (AVS), are based in part on frame-to-frame differences, and generally require a certain number of frames over which the differences are calculated for the compression. Reversing the process at the receiver's decoder requires a buffer at the decoder input store a minimum number of video frames before starting the decoding.

This input buffering requirement exists for all kinds DTV that distribute compressed video data, not just IPTV. However, the input buffering requirement may be particularly felt in, and may be particularly limiting to IPTV. This is because, due to its fundamental method and operation, IPTV provides a user, at least theoretically, with a potential for having any extremely large, almost unlimited, number of channels to select from. But, as has also been long known IPTV, this offering of a potential ocean for “channel surfing” may be substantially stifled by a thus far persistent shortcoming in that the user, although starting his or her surfing looking at an ocean of channels on his/her video controller may, after experiencing an extended zapping time after each of the surf clicks, be left with a negative experience.

### SUMMARY

Exemplary embodiments provide, among other features and benefits, a DTV system having a system processing delay, and therefore a zapping time that is minimized, on a per-channel basis, according to the coding standard of the next channel. As will be understood from the entirety of this disclosure, these and other features and benefits of the various embodiments provide, for example, a shorter average zapping time. This will be particularly beneficial for users surfing through what will likely be an increasingly large number of channels becoming available through DTV systems. Also among features and benefits of the various embodiments is that zapping time may automatically, at least from the user's perspective, conform to updates and changes of encoding standards and protocols.

As identified by the present inventors, the feature of a dynamic, per-channel conformance of the system processing delay to the channel's encoding standard, as opposed to a fixed system processing delay common for all video standards supported by a platform enable, among other features and benefits, a digital receiver such as, for example a Digital TV platform (DTV platform and a Set-Top Box (STB) providing decoding and playback of multiple video standards without the substantial cost in zapping time, i.e., impact to the user's convenience, incurred in prior art systems having such a feature.

As further identified by the present inventors, another among the features and benefits of one or more of the exemplary embodiments is a dynamic configuration buffer size, adjusted as per different video standards, which further provides optimizing of buffer usage in systems having the embodiments.

According to one exemplary embodiment a digital multimedia receiver and decoder system includes a system delay controller to receive a channel select data identifying a packet stream channel and, based at least in part on the channel select data, to generate a video coding standard identifier data and an optimal input buffer delay data, and includes an input delay buffer having a packet stream input to receive a packet stream and to output a corresponding delayed packet stream at a buffer delay based, at least in part, on the optimal input buffer delay data and, further, includes a reconfigurable video decoder to decode the delayed packet stream according to a decoding process based on the video coding standard identifier data, and to output a corresponding sequence of video frames.

According to one aspect, the system delay controller may also generate an optimal system processing delay data based, at least in part, on the video coding standard identifier data and, further, the reconfigurable video decoder may include a reconfigurable delay to output the corresponding sequence of video frames at a decoder processing delay based, at least in part, on the optimal system processing delay data.

According to another exemplary embodiment, a digital multimedia receiving and decoding method includes receiving a channel select data identifying a packet stream channel, generating a video coding standard identifier data based, at least in part on the channel select data, and generating an optimal input buffer delay data based, at least in part, on the video coding standard data. Also according to this one exemplary embodiment, a method further includes receiving a packet stream and outputting a corresponding delayed packet stream at a buffer delay based, at least in part, on the optimal input buffer delay data, and decoding the delayed packet stream according to a decoding process based on the video coding standard identifier data, and to output a corresponding sequence of video frames.

According to one aspect, the method may further generate an optimal system processing delay data based, at least in part, on the video coding standard identifier data and, further, the decoding the delayed packet stream may include a reconfigurable delaying to output the corresponding sequence of video frames at a decoder processing delay based, at least in part, on the optimal system processing delay data.

The above-summarized illustrative examples of advances and features of the invention, and of its various exemplary embodiments and aspects, are not intended to be exhaustive or limiting of the possible advantages that may be realized. Other advantages of the various exemplary embodiments will be apparent from the various embodiments and aspects that are further described with illustrative detail, and persons of ordinary skill in the art will, upon reading this disclosure, readily identify further variations within the scope of the appended claims, as well as additional applications.

### BRIEF DESCRIPTION OF THE DRAWINGS

FIG. 1 shows one example functional schematic representing one or more example systems having, and providing various methods according to, various exemplary embodiments;

FIG. 2 shows one example functional flow schematic of one or more example flows according to one or more systems and methods in accordance with, various exemplary embodiments; and

FIG. 3 shows one example of functional schematic of one illustrative implementation of a user platform according to one or embodiments, and which may implement, for example, the user decoding platform within the FIG. 1 example arrangement.

### DETAILED DESCRIPTION

Various exemplary embodiments are described in reference to specific example arrangements, to assist a person of ordinary skill in forming an understanding of the invention and its various embodiments that is sufficient to readily practice the invention. The scope of the embodiments of this invention, however, is not limited to the specific illustrative examples that are presented. Instead, as will be readily recognized by persons of ordinary skill in the relevant arts based on this description, other configurations and arrangements may be implemented.

As will be appreciated by persons of ordinary skill in the art, for clarity of illustration figures may not be drawn to scale. For example, certain depictions may have distortion of shape and/or exaggeration of relative proportions, for purposes of a clear depiction of a whole.

To avoid obscuring novel features and aspects, and as will be readily understood by persons of ordinary skill in the art upon reading this description, various details of algorithms and hardware that are well known to such persons are omitted, except where such details pertain to particular operations of the features and aspects.

Example embodiments and aspects may be described separately, or as having certain differences. Separate description or description of differences, however, does not necessarily mean the respective embodiments or aspects are mutually exclusive. For example, a particular feature, function, or characteristic described in relation to one embodiment may be included in, or adapted for other embodiments.

In one example system having, or implementing one or more embodiments, a multimedia source may broadcast or otherwise distribute a plurality of different multimedia or DTV channels. Each of the plurality of different DTV channels may have its content compressed according to one of a given plurality of coding standards. At least one user has a DTV playback system to receive one or more of the channels and, selects one of these channels and decodes the selected channel into a packet stream.

According to one aspect, the multimedia source may connect to the Internet, or other wide-area network, and each of the packet streams sourced may be according to one or more given transport protocols, and each packet stream may carry one more multimedia or other information channels as corresponding packet payloads. The packet payloads may be encoded for purposes such as bandwidth compression, according to any from a given plurality of coding standards such as, for illustrative example, MPEG-2, H.264 also known as “MPEG4-AVC, and AVS.

According to one aspect, the source may be an IPTV service provider's head end, or equivalent, connected to a wide area network such as, for example, the Internet, to which the plurality of end users are also connected. The head end may distribute, or source, for example, a plurality of different multimedia channels, as a corresponding plurality of different packet streams. The head end may be embodied as a distributed resource on the Internet such as, for example, one or more streaming data concentrators or aggregators, each receiving multimedia content from, for example, each of a plurality various multimedia content providers. It will also be understood that the implementation of the “head end” of the IPTV service provider is not necessarily particular to the embodiment and may, for example be implemented in accordance with conventional practices of IPTV head ends.

In one or more example embodiments, each of the packet streams sourced by the multimedia source, e.g., the head end according to an IPTV aspect, may be according to one or more given transport protocols, and each packet stream may carry one more multimedia or other information channels as corresponding packet payloads. It will be understood that packet transport protocols may not be particular to the present embodiments and, therefore, further detailed description is omitted. The packet payloads may be encoded for purposes such as bandwidth compression, according to any from a given plurality of coding standards such as, for illustrative example, MPEG-2, H.264 also known as “MPEG4-AVC,” and AVS.

According to one aspect, one or more user stations may include, for example, a multimedia presentation apparatus such a video display with audio speakers, connected by a transmission path, such as a cable, to an audio/video common multimedia output from a STB or equivalent that, in turn connects to the Internet.

It will be understood, with respect to all embodiments, that unless otherwise stated or made otherwise clear from a particular context, the term “STB,” as it relates to implementation, means a functional resource, and not necessarily a particular hardware unit. For example, according to one or more aspects, the STB functional resource may be included in a DTV user platform that, at one end, interfaces to the Internet and, at another end, provides video and audio signals to the user's video display and audio speakers. Accordingly, for purposes of this description, the term “DTV user platform” will be used to reference the user resource that interfaces to the Internet, performs IPTV or equivalent protocol signaling between the user and the IPTV resources, performs all packet stream reception and decoding and provides video and audio signals to the user's video display and audio speakers.

As will also be understood, connection of the DTV user platform to the Internet is not necessarily particular to the embodiments and may, for example, be implemented as a link to a home local area network (LAN) router, or equivalent, that in turn connects to, for example, a cable or DSL modem to an Internet Service Provider, (ISP) or equivalent service.

According to one or more aspects, communication between the DTV user platform and the source, e.g., the IPTV service provider's head-end, is not necessarily particular to the embodiments. For example, in an IPTV embodiment, connection may be through a currently existing IPTV multicasting system such as, for example, an IGMP system embodied on an environment of, for example, a plurality of interconnected routers distributed within, or connecting to the Internet, at various positions between the IPTV head-end, all the way downstream to the DTV user platform.

According to one aspect of one or more embodiments, the communication processes and protocols between the DTV user platform and the DTV service provider's resources for changing channels are not particular to the embodiments, and may be implemented according to such communication processes and protocols currently known in the DTV arts. Further, as will be understood by persons of ordinary skill in the DTV arts upon reading this disclosure, according to one or more aspects, a DTV user platform may be implemented by, for example, various modifications to one or more of the available off-the-shelf (OTS) IPTV STBs and, further, a selection of an appropriate OTS STB, as well as the necessary modifications, may be readily performed by persons of ordinary skill in the IPTV art based on this disclosure.

According to one aspect of or more of the embodiments, the DTV user platform may include a reconfigurable DTV decoder, the DTV decoder preferably having processing resources for demultiplexing the received packet stream into an encoded video packet stream and an encoded audio packet stream, and decoding the encoded video packet stream and encoded audio stream into output video frames and audio playback data, respectively, based on any from a plurality of given decoding standards, such as, for illustrative example, MPEG-2, H.264 and AVS. According to one aspect, decoding of the encoded video packet stream and encoded audio stream, respectively, may be performed by a reconfigurable DTV video decoder and a reconfigurable DTV audio decoder, into the output video frames and audio playback data. According to one aspect, the reconfigurable DTV decoder may include video frame buffers and audio buffers configurable, for example, to synchronize the output video frames and audio playback data, prior to input to the user's video display and speakers.

According to one aspect of one or more embodiments, a reconfigurable DTV decoder applies a selectable decoder processing delay, where the decoder processing delay is automatically set by, for example, a controller of the DTV user platform, based on the encoding, e.g., compression, standard of the channel received. This aspect will be referenced as the “encoding-based variable decoder processing delay.”

According to one aspect, the DTV user platform includes a reconfigurable DTV decoder having, or arranged with, a decoder input buffer having a depth, and therefore a delay, that is automatically set based on the encoding, e.g., compression, standard of the channel received. This input buffer aspect will be referenced hereinafter as the “encoding-based variable-delay input buffer,” and the corresponding delay feature will be referenced as the “encoding-based variable input buffer delay.”

According to one aspect the encoding-based variable-delay input buffer may be arranged after the demultiplexer of the reconfigurable DTV decoder. In such an arrangement, the encoding-based variable input buffer delay is applied only to the encoded video packet stream at, for example, an input to the reconfigurable DTV video decoder section of the DTV decoder. Such an arrangement, as will be understood, is only one example. Alternatively, an encoding-based variable-delay input buffer according to one or embodiments may be arranged before the demultiplexer of the reconfigurable DTV decoder, and corresponding delays, readily identified and implemented by persons of ordinary skill, effecting synchronization of the final recovered video signal and the final recovered audio may be included.

According to one aspect, control of the encoding-based variable decoder processing delay, and of the encoding-based variable input buffer delay may be implemented by, for example, as a delay storage and selection control feature of the DTV user platform. This control feature may be configured, for example, to generate an encoding-based system delay control signal, having an encoding-based input buffer delay control signal and, according to one aspect, an encoding-based variable decoder processing delay signal. According to one aspect, these example components signals of the encoding-based system delay control signal may be provided to the reconfigurable DTV video decoder and to the encoding-based variable-delay input buffer.

Further with respect to the delay storage and selection control aspect, it will be understood that all, or portions of the delay storage and selection control aspect may be included in or, in the alternative, may be separate from the encoding-based variable-delay input buffer. It will also be understood, upon reading this description, that the delay storage and selection control aspect of a DTV user platform according to one or more embodiments may control the delay of the encoding-based variable-delay input buffer based, at least in part, on other parameters, additional to the coding standard of the channel received. Therefore, it will be understood that, unless otherwise stated or otherwise made clear from a particular context, the term “encoding-based input buffer delay control signal,” means a control signal based at least in part on, but necessarily entirely on, the coding standard of the particular channel associated with the received streaming packets.

According to one aspect, generation of the encoding-based input buffer delay control signal of the encoding-based system processing delay control signal is based on the coding standard of the received channel, and may, but is not necessarily, further based on other input buffer delay factors.

Further according to one aspect, one input buffer delay factor additional to the coding standard may be employed to prevent, or to maintain within a given system video quality requirement, data under run or data overrun from occurring at the input of the reconfigurable DTV video decoder. As will be understood by persons of ordinary skill in the DTV arts, data under run/overrun at an input buffer of a video decoder may result from, for example, fluctuations in the bit rate of the incoming bit stream. These and other causes of data under run/overrun, as well as system considerations for setting the input buffer depth to maintain acceptable data under run/overrun are known to persons skilled in the relevant arts and, therefore, further detailed description is omitted.

Pertaining to the aspect of the generating the encoding-based input buffer delay control signal according to the coding standard, a preferred relation of the delay to the coding standard may be illustrated by one example comparison, such as a typical input buffer delay necessary in a conventional MPEG-2 decoder, compared to a typical input buffer delay necessary in a conventional H.264 decoder. More particularly, according to the MPEG-2 standard the max difference between Program Clock Reference (PCR) and Presentation Time Stamp (PTS) is one second. In contrast, according to the H.264 standard the max difference between PCR and PTS is ten seconds. To provide for this encoding-based difference, according to one more aspects the DTV user platform may maintain a table, or equivalent, such as the illustrative example Table I below, having an updated association of each channel's encoding standard.

TABLE I

| | Channel# | | | | | | | | |
|---|---|---|---|---|---|---|---|---|---|
| | 1 | 2 | 3 | 4 | 5 | 6 | 7 | 8 | 9 |
| Actual | H.264 | H.264 | MPEG-2 | MPEG-2 | MPEG-2 | MPEG-2 | MPEG-2 | MPEG-2 | H.264 |
| channel | | | | | | | | | |

Referring to Table I, according to one or more aspects, maintaining a table or equivalent with per-channel coding information, at or otherwise local to the STB or other user decoding resource eliminates the need for the STB to execute steps to identify the coding standard of the next channel at each zapping instance.

In a conventional IPTV system, the time delay measured from the moment the user enters a channel change command to the time the user sees an acceptable picture on his or her video screen may be termed a “system processing delay.” System processing delay in a typical conventional IPTV system consists, generally, of a sum of acquisition delay (e.g., frontend delay)+demultiplexing delay+decoding delay+postprocessing delay+display delay. The general theory, typical causes and typical describing parameters of each these delays are well known to persons of ordinary skill in the DTV arts and, therefore, further detailed description will be omitted.

The decoding delay may be separated into three components: input buffering delay; decoder processing delay; and output buffering delay, used, as it can be optional, as will be described in greater detail in later sections. Input buffering delay depends on the ISO/IEC standard specification (e.g., bit rate, level support, and minimum buffer requirement). As will be understood by persons of ordinary skill in the DTV arts input buffering delay may also depend on the buffer model used by the system to accommodate additional requirements.

According to one or more aspects of one or more embodiments, the DTV user platform may maintain a table of the decoder processing delay for each of the video standards supported by the platform's reconfigurable DTV decoder. Referring to Table I above, in one example in accordance with one or embodiments the DTV user platform maintains a table, or equivalent, having the decoder processing delay for each of the example video coding standards appearing in the example table, i.e., MPEG-2 and H.264.

According to one aspect, the DTV user platform may be configured to determine, in association with a channel zapping such as, for example, the user entering a change channel command, whether an video standard change is actually required in the reconfigurable DTV decoder of the platform. Further to at least this one aspect, the DTV user platform may be configured to trigger or to perform, in response to a determining a need for an actual video standard change, a setting of an appropriate and optimal, i.e., shortest acceptable system delay. This optimal delay may then be added to each PTS value extracted from the input bit stream. Further, according to one aspect of one or embodiments, the user DTV platform may separately control the encoding-based variable decoder processing delay and the encoding-based variable-delay input buffer, to optimally achieve the channel-specific optimal decoding delay.

According to one aspect, the user DTV platform may perform a separate control of the encoding-based variable decoder processing delay and the encoding-based variable-delay input buffer by generating a system delay control data, having a processing delay control data, setting the decoder processing delay, and an input buffer depth control data, setting the input buffer depth or delay. This feature of specific, separate control of the input buffer depth or delay to an optimal minimum provides, among other benefits, an optimally short zapping time because the time required to fill the input buffer to the required depth is often a substantial, if not majority contributor to the zapping time.

Accordingly, as may be readily seen by persons of skill in the relevant arts, one of the various benefits of the embodiments is that, for each zap to a next channel, since the buffer input depth is set according to the compression standard and protocol of that next channel, the cost in zapping time is no more than required for the channel's particular coding, or compression standard. This contrasts to an input buffer having a depth that is not dynamic with respect to the compression standard, as for such a buffer the depth must be set to a common maximum requirement.

According to one aspect, the user DTV platform may include an output delay buffering of frames that are output by the reconfigurable DTV video decoder. Preferably, according to one aspect, such output delay buffering may be configured to be channel-specific, preferably based, at least in part, on the channel's video coding standard.

Further to one aspect having output delay buffering of frames, determination of whether to include a reconfigurable output delay feature according to this aspect may be application-specific. For example, an output buffer delay feature may be preferred in a system application where average decoding time is on par with a real time requirement, but exhibits a peak decoding time for certain random frames. As can be readily understood by persons of skill, a feature in accordance with this aspect may be included where, to accommodate this certain type of real time system behavior, the user DTV platform preferably decodes early and provides adequate buffering of decoded frames.

Further to the above-described example aspect providing output buffering, the various video coding standards supported by the user DTV platform may be a relevant factor. As one illustrative example, in an example system supporting MPEG-2 and H.264, such a system may not show a degraded performance in the decoding and playback MPEG-2 streams, but may exhibit decoding peaks for H.264 playback. In such a scenario, it may be preferable to include an output buffering delay for the H.264 playback to provide, for example, an acceptably smooth playback.

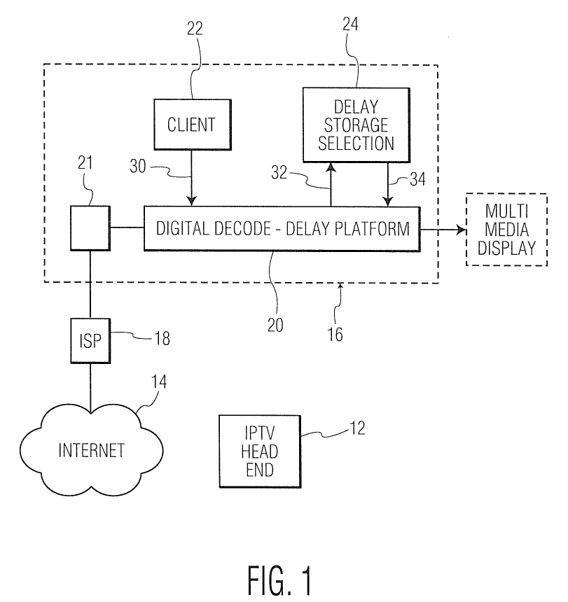

FIG. 1 shows one example systemlo for one or more embodiments. The FIG. 1 example system 10 is described in reference to IPTV, but this is only one illustrative example embodiment, and a person or ordinary skill in the DTV arts may readily map the functions onto other DTV environments that employ multichannel broadcasting of compressed multimedia data. It will be understood that FIG. 1 represents the example 10 as functional blocks, and that these may or may not represent a corresponding structural arrangement or allocation and distribution of functions within any structural arrangement. Referring now to FIG. 1, the example system 10 includes an IPTV service provider's head end 12, or equivalent, connected to a wide area network 14 such as, for example, the Internet, and one or more reconfigurable, channel-based system processing delay multimedia decoder/display platforms 16, generically termed “channel-specific system processing delay DTV platforms,” or “CSSPD DTV” platforms. An Internet access resource 18, such as an Internet Service Provider (ISP) interfaces the depicted example CSSPD DTV platform system 16 to the Internet 14. The IPTV head end 12 may distribute, or source, for example, a plurality of different multimedia channels, as a corresponding plurality of different packet streams into the Internet 14. The IPTV head end 12 and the ISP 18 are not necessarily particular to the embodiments, and may be implemented in accordance with conventional practices.

With continuing reference to FIG. 1, the example CSSPD DTV platform system 16 comprises a digital TV, or equivalent, delay/decoder platform 20 to receive a packet stream PS from the ISP 18 through, for example, a front end interface 21 such as, for example, a conventional DSL modem (not shown) or cable modem (not shown), and to apply a configurable input buffer delay to the packet stream, based on buffer delay control signals described in greater detail at later sections, and to decode the delayed packet stream according to a selectable video or audio/video decoding standard, the decoding standard being selectable according to a channel-specific decoding standard control data, also described in greater detail at later sections.

Referring still to FIG. 1, the example CSSPD DTV platform system 16 includes a higher level control resource, labeled Client 22, and a resource labeled Delay Storage and Selection Block 24 to control the previously described input buffer delay applied by the delay/decoder platform 20 and, optionally, according to one aspect, to control the previously described configurable decoding delay feature of the delay/decoder platform 20. As will be understood, the Delay Storage and Selection Block 24 is a functional block that may, for example, be a component of the Client 22.

Referring to the FIG. 1 example 10, illustrative example data communications or calls between the Client 22, the delay/decoder platform 20 and the Delay Storage and Selection Block 24, are shown to describe one example implementation for controlling the input delay buffer depth of the delay/decoder platform 20 and, optionally, the configurable decoding delay feature of the delay/decoder platform 20. In FIG. 1, the illustrative example of data communications or calls for such control comprise, and are arbitrarily labeled in this description for purposes of reference, as a SetVideoStandard communication 30 from the Client 22 to the delay/decoder platform 20, a Video Standard Notification communication or call 32 from the delay/decoder platform 20 to the Delay Storage and Selection Block 24, and a Set System Processing Delay communication or call 34 from the Delay Storage and Selection Block 24 to the delay/decoder platform 20.

It will be understood, however, that the particular FIG. 1 depiction of control operations as data communications, i.e., from one functional block to another, is only for purposes of describing example functions. As will be understood by a person of ordinary skill in the art upon reading this description in its entirety, the described control, instead of using “communications” between hardware units (not shown) may, for example, be implemented within a single processing resource (not shown). It will also be understood that all of the FIG. labels for these control signals are arbitrary, and are only used to assist in referencing the individual example signals.

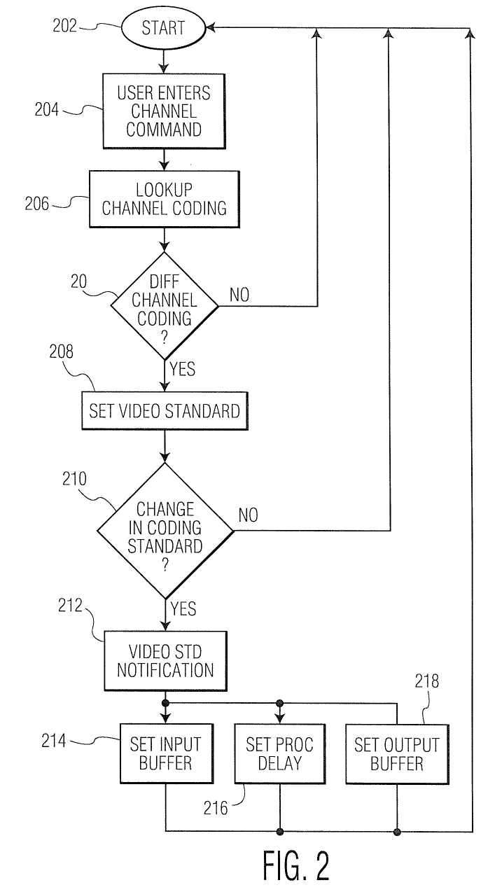

FIG. 2 shows one example functional flow schematic of one example flow 200 according to methods of the various exemplary embodiments, which may be carried out on, for example, the FIG. 1 example system 10, as well as on further systems according to the invention that will be apparent to persons skilled in the art based on this disclosure. One description of one illustrative flows according to the FIG. 2 example will be presented in reference to the FIG. 1 example system 10, and therefore its operations will be described using the FIG. 1 example labels for the depicted example of a control arrangement, namely the SetVideoStandard communication 30, Video Standard Notification communication 32, and the Set System Processing Delay communication or call 34. It will also be understood, though, that the described example according to FIG. 2 being in relation to FIG. 1 is only for purposes of a helpful reference for following the examples, and is not as a limitation on the systems or environments on which embodiments may be practiced.

Referring now to FIG. 2, one illustrative example may begin at a “Start” state, labeled 202, where a user (not depicted) is watching a particular program on the FIG. 1 video display 48. The user then wishes to find another, perhaps more interesting program and, at 204, enters a channel change command using, for example, a remote control (not shown in FIG. 1) that interfaces with, for example, the Client 22. The commanded channel change may, for example, be an “up” or “down” command, or may identify a specific next channel. It may be assumed that the Client 22 stores a list of available IPTV channels, as well as a program guide for display to the user, and further assumed that Client 22 stores a table, or equivalent, of the video encoding standard of each of the available channels such as, for example, the previously described Table I. As also previously described, maintaining a table or equivalent with per-channel coding information, at or otherwise local to the Client 22 or other user decoding resource eliminates the need for the Client 22 to execute steps to identify the coding standard of the next channel at each channel change or zapping instance.

Continuing with the example, referring to FIGS. 1 and 2, upon the user entering the channel command at 204 the Client 22 inspects, at 206, the channel coding information, e.g., the Table I example previously described, to identify, at 207, if the new channel has a video coding standard different from the current channel. If the Client 22 detects at 207 a video coding standard change, it initiates setting up a new video standard by sending, at 208, a SetVideoStandard communication or call 30 to the delay/decoder platform 20. The delay/decoder platform 20, in response, at 210 determines if there is an actual change in the video decoding standard it must apply to decode the next channel. If the delay/decoder platform 20 determines at 210 there is no change needed in the video coding standard, the operation returns to the Start 202. If, on the other hand, the delay/decoder platform 20 determines at 210 that a required change in the video coding standard is required it sends, at 212, the Video Standard Notification 32 to the Delay Storage and Selection Block 24. The Delay Storage and Selection Block 24, in response, selects and sets, at 214, an appropriate depth for the input buffer (not separately shown in FIG. 1) of the delay/decoder platform 20, and send this by a command, such as the System Processing Delay and Buffer Depth call 34, to the delay/decoder platform 20.

Referring to FIG. 2, in addition to setting the depth and delay of the input buffer at 314, according to one or more aspects described in greater detail at later sections, the delay/decoder platform 20 may also have a variable video decoding processing delay feature (not explicitly shown in FIG. 1). Further to these aspects the System Processing Delay and Buffer Depth call 34 may include a command to set the processing delay, such as represented in FIG. 2 as block 216. Further, according to one or more aspects described in greater detail at later sections, the delay/decoder platform 20 may also have a configurable delay output buffer feature (not explicitly shown in FIG. 1), to delay frames generated by the decoding process and, further to these aspects, the System Processing Delay and Buffer Depth call 34 may also include a command to set the delay of such an output buffer feature. Further to these aspects the System Processing Delay and Buffer Depth call 34 may also include a command to set this output buffer delay, such as represented in FIG. 2 as block 218.

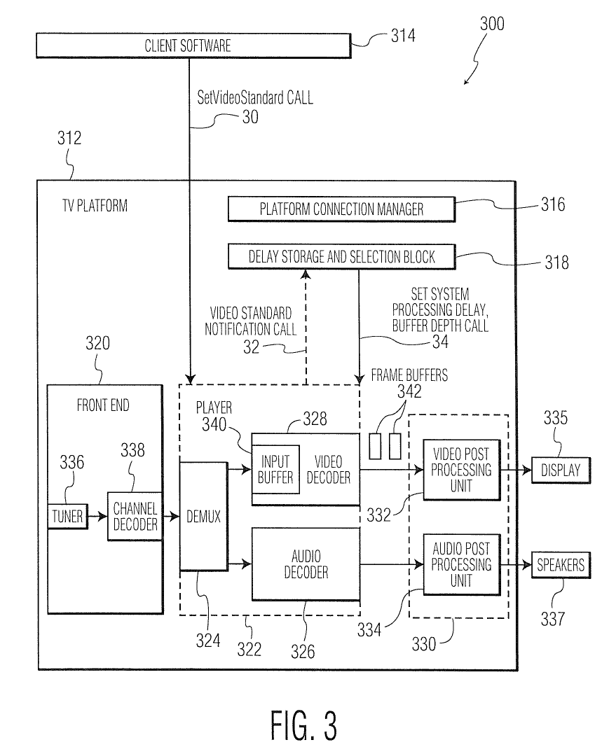

FIG. 3 shows one example of functional schematic of one illustrative implementation of a user system 300, according to one or embodiments, which may implement, for example, a user decoding platform, such as the CSSPD DTV platform system 16, within the FIG. 1 example 10.

Referring now to FIG. 3, the example user system 300 comprises a DTV reception resource such as the digital multimedia (DTV) platform 312, controlled by a system control resource such as that labeled as Client Software 314. The DTV platform 312 and Client Software 314 may be implemented by, for example, a conventional IPTV STB or equivalent, connected through an ISP to the Internet and an ISPTV service provider. The Client Software 314 is depicted as connecting to a Platform Connection Manager module, or block 306 and a Delay Storage and Selection module or block 308, each performing functions described in greater detail at later sections. As will be understood from the description of their respective functions, the Platform Connection Manager block 316 and the Delay Storage and Selection block 308 are functional blocks that may, for example, be a component of the Client Software resource 314.

Referring to FIG. 3, the depicted example DTV platform 312 has an optional front end receiver 320, a Digital TV (DTV) Player 322 comprising a demultiplexer 324, a preferably reconfigurable audio decoder 326 and a reconfigurable video decoder 328 and, in the depicted example, an audio/video post processing and rendering unit 330 comprising a video post processing and rendering unit 332 and an audio post processing unit 334. An example display unit 335 and example speakers 337 provide the user (not shown) with a video and audio presentation.

With continuing reference to FIG. 3, the front end receiver 320, shown in the example 300 as comprising a tuner 336 and a channel decoder 338, may be optional as it may be for connection to, for example, a satellite downlink, and therefore may be omitted in an environment having direct connection to the Internet through, for example, a user's cable modem or DSL modem (not shown).

Referring to FIG. 3, the reconfigurable video decoder 328 may include, or may otherwise connect to the channel decoder 338 through, an encoding-based variable-delay input buffer 340. The reconfigurable audio decoder 326 and the reconfigurable video decoder 328 are each switchable by, for example, the depicted SetVideoStandard output 30 from the Client Software 314 and/or the depicted Set System Processing Delay/Buffer Depth call or output 34 from the Delay Storage and Selection block 318, between any of a given plurality of coding standards such as, for example, MPEG-2, H.264 and AVS. The details of many usable decoding processes and algorithms for various coding standards, including MPEG-2 and H.264, are well known to persons of ordinary skill in the DTV arts and, therefore, except for example illustrations of their relation to novel aspects and features of the embodiments, further detailed description of such processes and algorithms is omitted.

With continuing reference to FIG. 3, according to one aspect, an output delay frame buffer 342 may be arranged between the reconfigurable video decoder 328 and the video post processing and rendering unit 332. The amount of delay applied by an output delay frame buffer such as item 342 may be channel-specific, preferably based, at least in part, on the channel's video coding standard. Persons of ordinary skill in the pertinent arts will understand, in view of the present disclosure, that determining whether to include a reconfigurable output delay feature such as item 342 may be application-specific. For example, as will be understood, an output buffer delay feature such as item 342 may be preferred in a system application where average decoding time is on par with a real time requirement, but exhibits a peak decoding time for certain random frames.

With continuing reference to FIG. 3, the DTV Player 322, as well as the post processing unit 330, may be, but are not necessarily, implemented by certain modifications of a current off-the-shelf digital player, as will be identifiable and understood by, and as can be readily performed by, persons of ordinary skill in the art from descriptions in greater detail at later sections of this disclosure.

Referring to the FIG. 3 example 300, the various features and functions of the example will be further illustrated by describing an example operation in reference to FIG. 2. It will be understood that describing the example operation in reference to FIG. 2 is only for purposes of using one helpful outlining example for following the examples, and that this not as a limitation on the methods according to the invention that may be practiced on the FIG. 3 example.

Continuing with the example, at 202 a user is watching a program at, at 204 enters a channel command, whereupon, at 206 the Client Software 314 inspects the channel coding information, e.g., the Table I, and to identify, at 307, if the video coding standard is different from the current channel. If at 207 the Client Software 314 detects no change in the video standard the process returns to the Start 202, waiting for the next user channel change command. If the Client Software 314 detects a video coding standard change, it sets up the new video standard by, for example, initiating the SetVideoStandard call 30 to the DTV Platform 312. The SetVideoStandard call 30 is then, according to the FIG. 3 example arrangement, received at the Platform Connection Manager 316 and routed to the DTV Player 322. The DTV Player 322 then determines if there is an actual change required in the video decoding standard that must be applied by the reconfigurable video decoder 328. It will be understood that the DTV Player 322 operation 210 of determining if there is an actual change required in the video coding standard of the reconfigurable video decoder 328 is only one example implementation of 210, and may be unnecessary by incorporating such a determination within the Client Software 314.

Continuing with the illustrative example above, referring to FIGS. 2 and 3, if at 210 the DTV Player 322 determines no actual change is required in the video coding standard of the reconfigurable video decoder 328 the process returns to the Start 202, where it waits until, for example, the next user change channel command. If, however, at 210 the DTV Player 322 determines that an actual change is required in the video coding standard of the reconfigurable video decoder 328, it sends the Video Standard Notification 32, identifying the video coding standard and, optionally, any other implementation-specific auxiliary information, to the Delay Storage and Selection module 316. The Delay Storage and Selection module 316, in response, selects and sets the appropriate system processing delay by a System Processing Delay and Buffer Depth command 34 to the DTV Player 322.

According to one aspect, configuring the system processing delay according to the video coding standard may be further extended within the video standard. For example, according to one aspect, in video standard such as H.264 the system processing delay may be generated based on additional parameters such as, for example, compliance level of the stream, bit rate of the stream and the like.

With continuing reference to FIG. 3, according to another aspect, a filter feature may be included in, for example, the reconfigurable video decoder 328, or the encoding-based variable-delay input buffer 340. For example, in MPEG-2 the max difference between Program Clock Reference (PCR) and Presentation Time Stamp (PTS) is one see and for H.264 the max difference is ten seconds. Further to one or more aspects, one example filter would prevent the user DTV platform 312, while configured to receive an IPTV channel having a video coding standard requiring a short input buffer depth, for erroneously decoding and displaying improper or disallowed date. For example, in a conventional IPTV receiving system, when the system processing delay is set to accommodate H.264 system delay, even though a particular channel being received is MPEG-2, if some erroneous (more than one see) PCR/PTS difference arrives then it will be treated as allowable and, as a result, will cause video degradation.

One illustrative example of the various benefits and advantages of the embodiments is seen by one realistic example of a user zapping through the example channel sequence depicted at Table I above. This example will also illustrate that during channel zapping the input video buffering is one of the major constituents for the overall zap time. For example, the input video buffering generally amounts to approximately 60% of the total zap time.

Continuing with this illustrative example, it will be assumed, using typical system processing delays, and hence zapping times, encountered with conventional IPTV and equivalent systems, respective system processing delays of 50 ms and 320 ms for MPEG-2 and H.264 are, based on observations of the present inventors, representative of such conventional systems. Referring to Table I, if a user is zapping in a channel sequence represented by the left-to-right direction of the table, it is seen that after the H.264 channel zaps, meaning channel No. 3 onwards, each zap provides a zap time reduction of 270(320-50) milliseconds. This saving of 270 ms in MPEG-2 channel zap is possible only by having a configurable system processing delay based on the actual video decoder being used.

The present invention and its various embodiments provide still further benefits and features. For example, in a typical conventional IPTV receiver and decoder, most of the input buffer (compressed) and output frame buffer (decoded) requirements are dependent on the video standard and level supported by that standard. By having the video standard detection and the input buffer configuration features if the present embodiments, a system designer may configure different buffers for different video standard playback and optimize the memory usage of the system.

As one example of the buffer optimization benefit, a typical MPEG-2 decoding and playback requires much less buffer resources than required for H.264 decoding and playback. In DVB transmission, MHEG data comes with MPEG streams and in such systems additional memory is needed for MHEG data processing. Employing one or more embodiments of the present invention, when switching to MPEG-2 standard, the saved input buffer may be utilized for MHEG processing, thereby optimizing employment of memory resources to meet greater system requirements at lower cost.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention.

Accordingly, the foregoing disclosure, description, and figures are for illustrative purposes only and do not in any way limit the invention, which is defined only by the claims.

We hereby claim:

1. A digital multimedia receiver and decoder system, comprising:
a system delay controller to receive a channel select data identifying a packet stream channel and, based at least in part on the channel select data, to generate a video coding standard identifier data and an optimal input buffer delay data;
an input delay buffer having a packet stream input to receive a packet stream and to output a corresponding delayed packet stream at a buffer delay based, at least in part, on the optimal input buffer delay data; and
a reconfigurable video decoder to decode the delayed packet stream according to a decoding process based on the video coding standard identifier data, and to output a corresponding sequence of video frames.

2. The digital multimedia receiver and decoder system of claim 1,
wherein the system delay controller further generates an optimal system processing delay data based, at least in part, on the video coding standard identifier data, and
wherein the reconfigurable video decoder includes a reconfigurable delay to output the corresponding sequence of video frames at a decoder processing delay based, at least in part, on the optimal system processing delay data.

3. The digital multimedia receiver and decoder system of claim 1, wherein the system delay controller is capable of determining if a change video standard is required, based on a current video standard configuration of the reconfigurable video decoder compared to the video coding standard identifier data and, based on said determining that a change video standard is required, to generate an updated optimal input buffer delay data.

4. The digital multimedia receiver and decoder system of claim 2, wherein the system delay controller is capable of determining if a change video standard is required, based on a current video standard configuration of the reconfigurable video decoder compared to the video coding standard identifier data and, based on said determining that a change video standard is required, to generate an updated optimal system processing delay data and an updated optimal input buffer delay data.

5. The digital multimedia receiver and decoder system of claim 1, further comprising a reconfigurable output frame buffer to receive the corresponding sequence of video frames and to output a corresponding delayed sequence of video frames, at a delay based, at least in part, on video coding standard identifier data.

6. The digital multimedia receiver and decoder system of claim 5, further comprising a video post processing and rendering unit to receive said delayed sequence of video frames and to output a corresponding output video signal.

7. The digital multimedia and decoder system of any of claims 1, 2, 3, 4 or 5, wherein said system delay controller includes a per-channel coding standard identifier table storing a plurality of packet stream channel coding standard identifier data, each said packet stream channel identifier datum identifying a packet stream channel and identifying a corresponding coding standard, and wherein said system delay controller generates the video coding standard identifier data and optimal input buffer delay data based on said table and said channel select data.

8. The digital multimedia receiver and decoder system of claim 1, further comprising:
a demultiplexer to receive an input multimedia packet stream having an encoded audio information data and an encoded video information data, and to generate a corresponding encoded video packet stream and a corresponding encoded audio packet stream, and to input the encoded video packet stream to said input delay buffer as said packet stream input; and
an audio decoder to receive the corresponding audio packet stream and to generate a corresponding decoded audio data.

9. The digital multimedia receiver and decoder system of claim 6, further comprising an audio post processing unit to receive said decoded audio data and to output a corresponding audio speaker signal.

10. A digital multimedia receiving and decoding method, comprising:
receiving a channel select data identifying a packet stream channel;
generating a video coding standard identifier data based, at least in part on the channel select data;
generating an optimal input buffer delay data based, at least in part, on the video coding standard data;
receiving a packet stream and outputting a corresponding delayed packet stream at a buffer delay based, at least in part, on the optimal input buffer delay data; and
decoding the delayed packet stream according to a decoding process based on the video coding standard identifier data, and to output a corresponding sequence of video frames.

11. The digital multimedia receiving and decoding method of claim 9, further comprising:
generating an optimal system processing delay data based, at least in part, on the video coding standard identifier data,
wherein the decoding the delayed packet stream includes delaying the output of the sequence of video frames at a decoder processing delay based, at least in part, on the optimal system processing delay data.

12. The digital multimedia receiving and decoding method of claim 9, further comprising:
determining if a change of said decoding process is required, based on a determining of the current decoding process and a comparison of said determined current decoding process to said video coding standard identifier data; and
based on said determining that change of said decoding process is required, generating an updated optimal input buffer delay data.

13. The digital multimedia receiving and decoding method of claim 11, further comprising:
determining if a change of said decoding process is required, based on a determining of the current decoding process and a comparison of said determined current decoding process to said video coding standard identifier data; and
based on said determining that change of said decoding process is required, generating an updated optimal input buffer delay data and an updated optimal system processing delay data.

14. The digital multimedia receiving and decoding method of claim 10, further comprising a receiving and delay buffering said corresponding sequence of video frames, said buffering including outputting a corresponding delayed sequence of video frames, at a delay based, at least in part, on video coding standard identifier data.

15. The digital multimedia receiving and decoding method of claim 11, further comprising a receiving and delay buffering said corresponding sequence of video frames, said buffering including outputting a corresponding delayed sequence of video frames, at a delay based, at least in part, on video coding standard identifier data.

16. The digital multimedia and decoder method of any of 10, 11, 12, 13 or 14, further comprising storing a per-channel coding standard identifier table at a location local to said receiving a packet stream, said table storing a plurality of packet stream channel coding standard identifier data, each said packet stream channel identifier datum identifying a packet stream channel and identifying a corresponding coding standard, and wherein said generating a video coding standard identifier data generates the video coding standard identifier data based on said table and said channel select data.
